(19) United States
(12) Patent Application Publication
(10) Pub. No.: US 2005/0216419 A1
(43) Pub. Date: Sep. 29, 2005

(54) Method and apparatus for acquiring and removing information regarding digital rights objects

(75) Inventors: Byung-Rae Lee, Yongin-si (KR); Tae-sung Kim, Seoul (KR); Kyung-im Jung, Seongnam-si (KR); Yun-sang Oh, Seoul (KR); Shin-han Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/091,825

(22) Filed: Mar. 29, 2005

Related U.S. Application Data
(60) Provisional application No. 60/575,757, filed on Jun. 1, 2004.

(30) Foreign Application Priority Data
Mar. 29, 2004 (KR) 10-2004-0021303
Mar. 29, 2004 (KR) 10-2004-0021304
Jun. 1, 2004 (KR) 10-2004-0039699

(51) Int. Cl. G06F 17/60

(52) U.S. Cl. 705/59

(57) ABSTRACT

A method and apparatus for acquiring and removing information regarding a digital rights object are provided. The method for acquiring removing information regarding a digital rights object includes receiving a request for data on a rights object from a device, processing the data on the rights object in response to the request, and providing the processed data to the device. The method of removing a digital rights object includes selecting information regarding a rights object to be removed, encrypting the selected information regarding the rights object using a common encryption key, embedding the encrypted information regarding the rights object into a signal to be transmitted to a portable storage device, and transmitting the signal to the portable storage device. A device requests information regarding a rights object from a portable storage device, receives the information regarding the rights object from the portable storage device, and removes an unnecessary rights object.

### CROSS-REFERENCE TO RELATED APPLICATIONS

This application claims priorities from Korean Patent Application No. 10-2004-0021303 filed on Mar. 29, 2004 in the Korean Intellectual Property Office, Korean Patent Application No. 10-2004-0021304 filed on Mar. 29, 2004 in the Korean Intellectual Property Office, Korean Patent Application No. 10-2004-0039699 filed on Jun. 1, 2004 in the Korean Intellectual Property Office, and U.S. Provisional Patent Application No. 60/575,757 filed on Jun. 1, 2004 in the United States Patent and Trademark Office, the disclosures of which are incorporated herein by reference in their entirety.

### BACKGROUND OF THE INVENTION

1. Field of the Invention

Apparatuses and methods consistent with the present invention relate to acquiring and removing information regarding digital rights objects, and more particularly, to acquiring and removing information regarding digital rights objects, in which a device requests information regarding a digital rights object from a portable storage device, receives the information regarding the digital rights object transmitted from the portable storage device in response to the request, and manages the information regarding the digital rights object so that digital rights management (DRM) is safely and efficiently performed between the device and the portable storage device.

2. Description of the Related Art

Recently, DRM has been actively researched and developed. DRM has been used and will be used in commercial services. DRM needs to be used because of the following various characteristics of digital content. That is to say, unlike analog data, digital content can be copied without loss and can be easily reused, processed, and distributed, and only a small amount of cost is needed to copy and distribute the digital content. However, a large amount of cost, labor, and time are needed to produce the digital content. Thus, when the digital content is copied and distributed without permission, a producer of the digital content may lose profits, and the producer's enthusiasm for creation may be discouraged. As a result, development of digital content business may be hampered.

There have been several efforts to protect digital content. Conventionally, digital content protection has been concentrated on preventing non-permitted access to digital content, permitting only people paid charges to access the digital content. Thus, people who paid charges for the digital content are allowed to access unencrypted digital content while people who did not pay charges are not allowed access. However, when a person who paid charges intentionally distributes the digital content to other people, the digital content can be used by the other people which did not pay charges. To solve this program, DRM was introduced. In DRM, anyone is allowed to freely access encoded digital content, but a license referred to as a rights object is needed to decode and execute the digital content. Accordingly, the digital content can be more effectively protected by using DRM.

The conception of DRM is illustrated in FIG. 1. DRM relates to management of contents (hereafter, referred to as encrypted contents) protected using a method such as encryption or scrambling and rights objects allowing access to the encrypted contents.

Referring to FIG. 1, a DRM system includes user devices 110 and 150 wanting to access content protected by DRM, a contents issuer 120 issuing content, a rights issuer 130 issuing a rights object containing a right to access the content, and a certification authority 140 issuing a certificate.

In operation, the user device 110 can obtain desired content from the contents issuer 120 in an encrypted format protected by DRM. The user device 110 can obtain a license to play the encrypted content from a rights object received from the rights issuer 130. Then, the user device 110 can play the encrypted content. Since encrypted contents can be circulated or distributed freely, the user device 110 can freely transmit the encrypted content to the user device 150. The user device 150 needs the rights object to play the encrypted content. The rights object can be obtained from the rights issuer 130. Meanwhile, the certification authority 140 issues a certificate indicating that the contents issuer 120 is authentic and the user devices 110 and 150 are authorized. The certificate may be embedded into devices used by the user devices 110 and 150 when the devices are manufactured and may be reissued by the certification authority 140 after a predetermined duration has expired.

DRM protects the profits of those producing or providing digital contents and thus may be helpful in activating the digital content industry. Although a rights object or encrypted content can be transferred between user devices, it is inconvenient as a practical matter. Accordingly, to facilitate move of rights objects and encrypted contents between devices, efficient move of data between a device and a portable storage device intermediating between the devices is desired.

### SUMMARY OF THE INVENTION

The present invention provides a method and apparatus for acquiring a digital rights object's information, in which a device requests information regarding a rights object from a portable storage device, receives the information regarding the rights object transmitted from the portable storage device in response to the request, and manages the information regarding the digital rights object so that DRM is safely and efficiently performed between the device and the portable storage device.

The present invention also provides a method and apparatus for removing a digital rights object, by which an unnecessary rights object is removed based on information regarding the rights object, thereby reducing a load of a device or a portable storage device and preventing content from being consumed by an unauthorized rights object.

According to an aspect of the present invention, there is provided a method of acquiring information regarding a digital rights object, including receiving a request for data on a stored rights object from a device, accessing the rights object in response to the request of the device, processing the data on the rights object, and providing the processed data to the device.

According to another aspect of the present invention, there is provided a method of acquiring information regarding a digital rights object, including receiving a request for data on all available rights objects from a device, accessing all available rights objects in response to the request, processing the data on all available rights objects, and providing the processed data to the device.

According to still another aspect of the present invention, there is provided a method of acquiring information regarding a digital rights object, the method including receiving a request for data on all available rights objects from a device, accessing all available rights objects in response to the request and processing the data on all available rights objects, and providing the processed data to the device.

According to a further aspect of the present invention, there is provided a method of acquiring information regarding a digital rights object, the method including performing authentication with a portable storage device and generating an encryption key, requesting data on all available rights objects from the authenticated portable storage device, and receiving processed data on all available rights objects from the portable storage device.

According to a yet another aspect of the present invention, there is provided a method of removing a digital rights object, the method including selecting information regarding a rights object to be removed, encrypting the selected information regarding the rights object using a common encryption key, embedding the encrypted information regarding the rights object into a signal to be transmitted to a portable storage device, and transmitting the signal to the portable storage device.

According to still another aspect of the present invention, there is provided a method of removing a digital rights object, the method including receiving encrypted rights object removal information from a device, decrypting the encrypted rights object removal information using a common encryption key, accessing a rights object corresponding to the decrypted rights object removal information, and removing the accessed rights object.

### BRIEF DESCRIPTION OF THE DRAWINGS

The above and other aspects of the present invention will become more apparent by describing in detail exemplary embodiments thereof with reference to the attached drawings in which:

FIG. 1 is a schematic diagram illustrating the concept of DRM;

FIG. 2 is a schematic diagram illustrating the concept of DRM using a secure multimedia card (MMC);

FIG. 3 is a block diagram of a device according to an exemplary embodiment of the present invention;

FIG. 4 is a block diagram of a secure MMC according to an exemplary embodiment of the present invention;

FIG. 5 is a table illustrating the format of a rights object according to an exemplary embodiment of the present invention;

FIG. 6 is a table illustrating constraints given to permission shown in FIG. 5;

FIG. 7 illustrates authentication between a device and a secure MMC;

FIG. 8 is a flowchart of a protocol by which a device acquires information regarding a specified rights object from a secure MMC in an exemplary embodiment of the present invention;

FIG. 9 is a flowchart of a protocol by which a device acquires information regarding all available rights objects from a secure MMC in an exemplary embodiment of the present invention;

FIG. 10 is a flowchart of a protocol for removing a rights object specified by a device from a secure MMC in an exemplary embodiment of the present invention;

FIGS. 11A through 11E illustrate examples of formats of an instruction, instruction parameters, and an output response which are used when a device transmits information regarding content desired by a user to a secure MMC in the protocol illustrated in FIG. 8 in an exemplary embodiment of the present invention;

FIGS. 12A through 12E illustrate examples of formats of an instruction, instruction parameters, and an output response which are used when a device requests information regarding a rights object corresponding to content from a secure MMC in the protocol illustrated in FIG. 8 in an exemplary embodiment of the present invention; and

FIGS. 13, 14 and 15 illustrate examples of the format of information regarding a rights object provided by a secure MMC in the protocol illustrated in FIG. 8;

FIGS. 16A through 16E illustrate examples of formats of an instruction, instruction parameters, and an output response which are used when a device requests information regarding all available rights objects in the protocol illustrated in FIG. 9 in an exemplary embodiment of the present invention; and

FIGS. 17A through 17E illustrate examples of formats of an instruction, instruction parameters, and an output response, which are used when a device requests a secure MMC to remove a particular rights object in the protocol illustrated in FIG. 10 in an exemplary embodiment of the present invention.

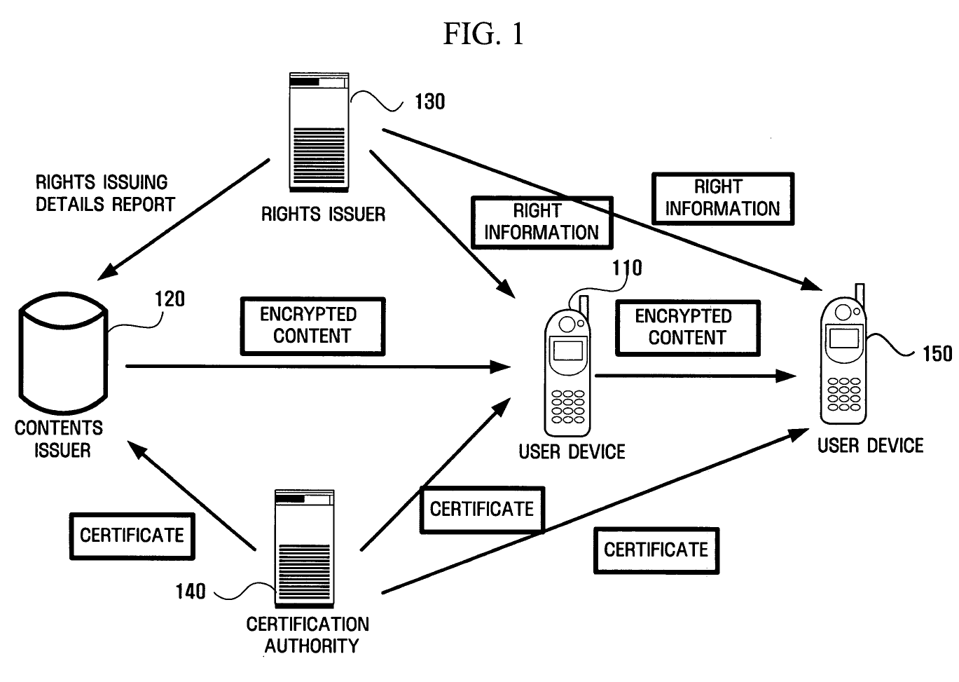

### DETAILED DESCRIPTION OF THE EXEMPLARY EMBODIMENTS OF THE INVENTION

The present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Hereinafter, exemplary embodiments of the present invention will be described in detail with reference to the attached drawings.

Before the detailed description is set forth, terms used in this specification will be described briefly. Description of terms is to be construed provided for a better understanding of the specification and terms that are not explicitly defined herein are not intended to limit the broad aspect of the invention.

Public-Key Cryptography

Public-key cryptography is referred to as an asymmetric cipher in which a key used for encryption is different from a key used for decryption. A public-key algorithm is open to the public, but it is impossible or difficult to decrypt original content with only a cryptographic algorithm, an encryption key, and ciphered text. Examples of a public-key cryptographic system include Diffie-Hellman cryptosystems, RSA cryptosystems, ElGamal cryptosystems, and elliptic curve cryptosystems. The public-key cryptography is about 100-1000 times slower than symmetric-key cryptography and is thus usually used for key exchange and digital signature not for encryption of content.

Symmetric-Key Cryptography

Symmetric-key cryptography is a symmetric cipher referred to as secret-key cryptography using the same key encryption and decryption. A data encryption standard (DES) is a most usual symmetric cipher. Recently, applications using an advanced encryption standard (AES) have increased.

Certificate

A certification authority certifies users of a public key with respect to a public-key cipher. A certificate is a message containing a public key and a person's identity information which are signed by the certification authority using a private key. Accordingly, the integrity of the certificate can be easily considered by applying the public key of the certification authority to the certificate, and therefore, attackers are prevented from modulating a user's public key.

Digital Signature

A digital signature is generated by a signer to indicate that a document has been written. Examples of a digital signature are an RSA digital signature, an ElGamal digital signature, a DSA digital signature, and a Schnorr digital signature. When the RSA digital signature is used, a sender encrypts a message with his/her private key and sends the encrypted message to a recipient. The recipient decrypts the encrypted message. In this case, it is proved that the message has been encrypted by the sender.

Random Number

A random number is a sequence of numbers or characters with random properties. Since it costs a lot to generate a complete random number, a pseudo-random number may be used.

Portable Storage Device

A portable storage device used in the present invention includes a non-volatile memory such as a flash memory which data can be written to, read from, and deleted from and which can be connected to a device. Examples of such portable storage device are smart media, memory sticks, compact flash (CF) cards, xD cards, and multimedia cards. Hereinafter, a secure MMC will be explained as a portable storage device.

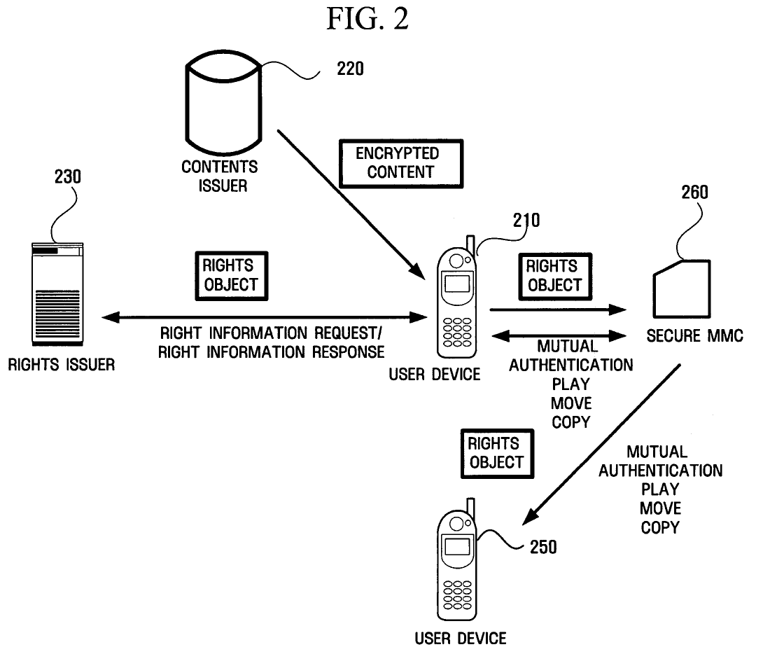

FIG. 2 is a schematic diagram illustrating the concept of DRM using a secure multimedia card (MMC).

A user device 210 can obtain encrypted content from a contents issuer 220. The encrypted content is content protected through DRM. To play the encrypted content, a Rights Object (RO) for the encrypted content is needed. An RO contains a definition of a right to. content, constraints to the right, and a right to the RO itself. An example of the right to the content may be a playback. Examples of the constraints may be the number of playbacks, a playback time, and a playback duration. An example of the right to the RO may be a move or a copy. In other words, an RO containing a right to move may be moved to another device or a secure MMC. An RO containing a right to copy may be copied to another device or a secure MMC. When the RO is moved, the original RO before the move is deactivated (i.e., the RO itself is deleted or a right contained in the RO is deleted). However, when the RO is copied, the original RO may be used in an activated state even after the copy.

After obtaining the encrypted content, the user device 210 may request a rights object (RO) from a rights issuer 230 to obtain a right to play. When the user device 210 receives the RO together with an RO response from the rights issuer 230, the user device 210 can play the encrypted content using the RO. Meanwhile, the user device 210 may transfer the RO to a user device 250 having a corresponding encrypted object through a portable storage device. The portable storage device may be a secure MMC 260 having a DRM function. In this case, the user device 210 performs mutual authentication with the secure MMC 260 and then moves the RO to the secure MMC 260. To play the encrypted content, the user device 210 requests a right to play from the secure MMC 260 and receives the right to play, i.e., a content encryption key, from the secure MMC 260. The user device 210 can play the encrypted content using the content encryption key. Meanwhile, after performing mutual authentication with the user device 250, the secure MMC 260 can move the RO to the user device 250 or enable the user device 250 to play the encrypted content.

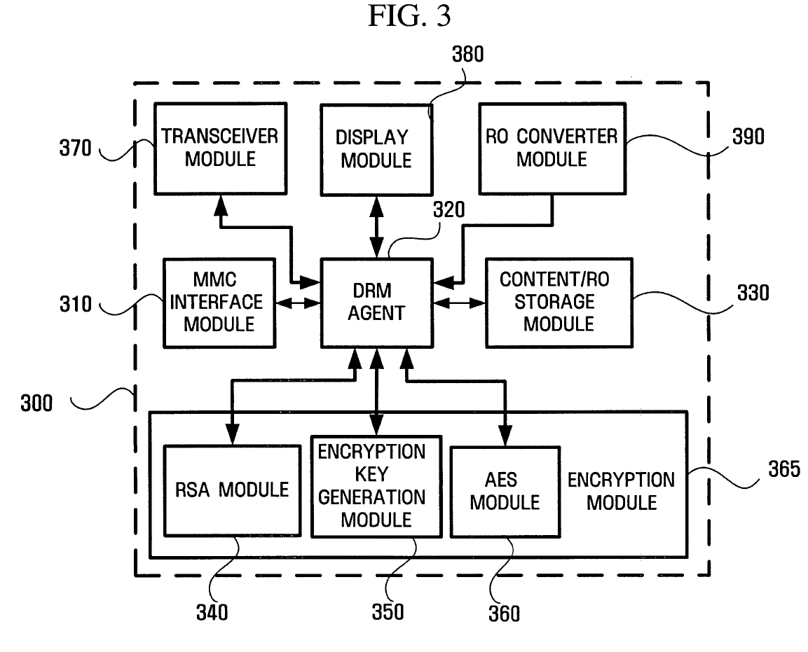

In exemplary embodiments of the present invention, authentication between a device and a secure MMC is needed to enable the device to use the secure MMC. An authentication procedure will be described in detail with reference to FIG. 3. Here, a subscript “M” of an object indicates that the object is possessed or generated by a device and a subscript “M” of an object indicates that the object is possessed or generated by a secure MMC.

FIG. 3 is a block diagram of a device 300 according to an exemplary embodiment of the present invention.

In the exemplary embodiment, the term ‘module’, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or secure MMC.

To implement DRM, the device 300 needs a security function, a function of storing content or an RO, a function of exchanging data with another device, for example, portable storage device or multimedia device, PDA, cellular phone., a data transmit/receive function allowing communication with a content provider or an RO issuer, and a DRM function. To perform these functions, the device 300 includes an encryption module 365 having an RSA module 340, an encryption key generation module 350, and an advanced encryption standard (AES) module 360 for the security function, a content/RO storage module 330 with a storage function, an MMC interface module 310 allowing data exchange with a secure MMC, and a DRM agent 320 controlling each module to perform a DRM procedure. In addition, the device 300 includes a transceiver module 370 for the data transmit/receive function and a display module 380 displaying content during playback. An encryption key generated by the an encryption key generation module 350 includes a session key used for encryption and decryption during communication between the device 300 and a secure MMC and a hashing key used to generate a hash value indicating whether information regarding an RO is modified.

The transceiver module 370 allows the device 300 to communicate with a content provider or an RO issuer. The device 300 can acquire an RO or encrypted content from an outside through the transceiver module 370.

The MMC interface module 310 allows the device 300 to be connected with the secure MMC. When the device 300 is connected with a secure MMC, fundamentally, the MMC interface module 310 of the device 300 is electrically connected with an interface module of the secure MMC. However, the electrical connection is just an example, and the connection may indicate a state in which the device 300 can communicate with the secure MMC through a wireless medium without contact.

The RSA module 340 performs public-key encryption. More particularly, the RSA module 340 performs RSA encryption according to a request from the DRM agent 320. In exemplary embodiments of the present invention, during authentication, the RSA encryption is used for key (random number) exchange or digital signature. However, the RSA encryption is just an example, and other public-key encryption may be used.

The encryption key generation module 350 generates a random number to be transmitted to a secure MMC and generates a session key and a hashing key using the generated random number and a random number received from the secure MMC. The random number generated by the encryption key generation module 350 is encrypted by the RSA module 340 and then transmitted to the secure MMC through the MMC interface module 310. Instead of generating the random number in the encryption key generation module 350, the random number may be selected from a plurality of random numbers provided in advance.

The AES module 360 performs symmetric-key encryption using the generated session key. More particularly, the AES module 360 uses AES encryption to encrypt a content encryption key from an RO with the session key and to encrypt other important information during communication with another device. In an exemplary embodiment of the present invention, the session key is used to encrypt an RO during move of the RO. The AES encryption is just an example, and other symmetric-key encryption such as DES encryption may be used.

The content/RO storage module 330 stores encrypted contents and ROs. The device 300 encrypts an RO according to the AES encryption using a unique key that cannot be read by another device or a secure MMC and decrypts the RO using the unique key to move or copy the RO to another device or a secure MMC. The encrypting of an RO using the unique key according to the symmetric-key encryption is just an example. Alternatively, an RO may be encrypted using a private key of the device 300 and may be decrypted using a public key of the device 300 when necessary.

The display module 380 visually displays playback of content whose RO permits playback. The display module 380 may be implemented by a liquid crystal display (LCD) device such as a thin-film transistor (TFT) LCD device or an organic electroluminescent (EL) display device.

The DRM agent 320 verifies whether information regarding an RO received from a secure MMC is modified. The verification can be performed based on a hash value generated by the secure MMC. The hash value is obtained using a hashing key generated by the encryption key generation module 350 and a published hash algorithm, e.g., Security Hash Algorithm1 (SHA1).

When requesting information regarding an RO or removal of an RO, a send sequence counter (SSC) indicating a transmission sequence may be generated and embedded into a request command to prevent the request command from being lost or an inauthentic command from being inserted between request commands by an unauthorized invader.

Meanwhile, the DRM agent 320 generates a removal condition, i.e., an identifier (ID) of an RO or a list of IDs of ROs, or an item related with right information of an RO to be removed. Accordingly, the DRM agent 320 has a function of retrieving right information from a received RO.

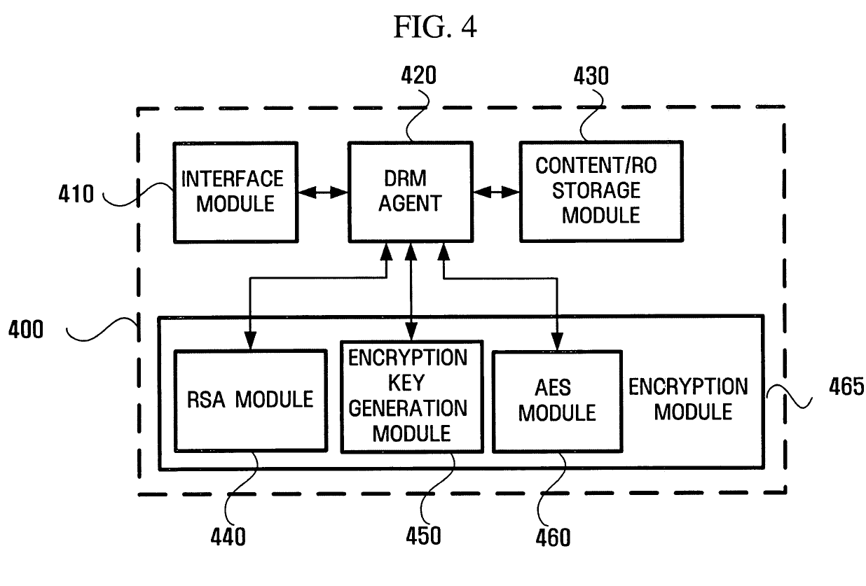

FIG. 4 is a block diagram of a secure MMC 400 according to an exemplary embodiment of the present invention.

To implement DRM, the secure MMC 400 needs a security function, a function of storing content or an RO, a function of exchanging data with another device, and a DRM function. To perform these functions, the secure MMC 400 includes an encryption module 465 having an RSA module 440, an encryption key generation module 450, and an AES module 460 for the security function, a content/RO storage module 430 with a storage function, an interface module 410 allowing data exchange with a device, and a DRM agent 420 controlling each module to perform a DRM procedure.

The interface module 410 allows the secure MMC 400 to be connected with a device. When the secure MMC 400 is connected with a device, fundamentally, the interface module 410 of the secure MMC 400 is electrically connected with an interface module of the device. However, the electrical connection is just an example, and the connection may indicate a state in which the secure MMC 400 can communicate with the device through a wireless medium without contact.

The RSA module 440 performs public-key encryption. More particularly, the RSA module 440 performs RSA encryption according to a request from the DRM agent 420. In exemplary embodiments of the present invention, during authentication, the RSA encryption is used for key (random number) exchange or digital signature. However, the RSA encryption is just an example, and other public-key encryption may be used.

The encryption key generation module 450 generates a random number to be transmitted to a device and generates a session key and a hashing key using the generated random number and a random number received from the device. The random number generated by the encryption key generation module 450 is encrypted by the RSA module 440 and then transmitted to the device through the interface module 410. Instead of generating the random number in the encryption key generation module 450, the random number may be selected from a plurality of random numbers provided in advance.

The AES module 460 performs symmetric-key encryption using the generated session key. More particularly, the AES module 460 uses AES encryption to encrypt a content encryption key from an RO with the session key and to encrypt other important information during communication with another device. In an exemplary embodiment of the present invention, the session key is used to encrypt an RO during move of the RO. The AES encryption is just an example, and other symmetric-key encryption such as DES encryption may be used.

The content/RO storage module 430 stores encrypted contents and ROs. The secure MMC 400 encrypts an RO according to the AES encryption using a unique key that cannot be read by other devices and decrypts the RO using the unique key to move or copy the RO to other devices. The encrypting of an RO using the unique key according to the symmetric-key encryption is just an example. Alternatively, an RO may be encrypted using a private key of the secure MMC 400 and may be decrypted using a public key of the secure MMC 400 when necessary.

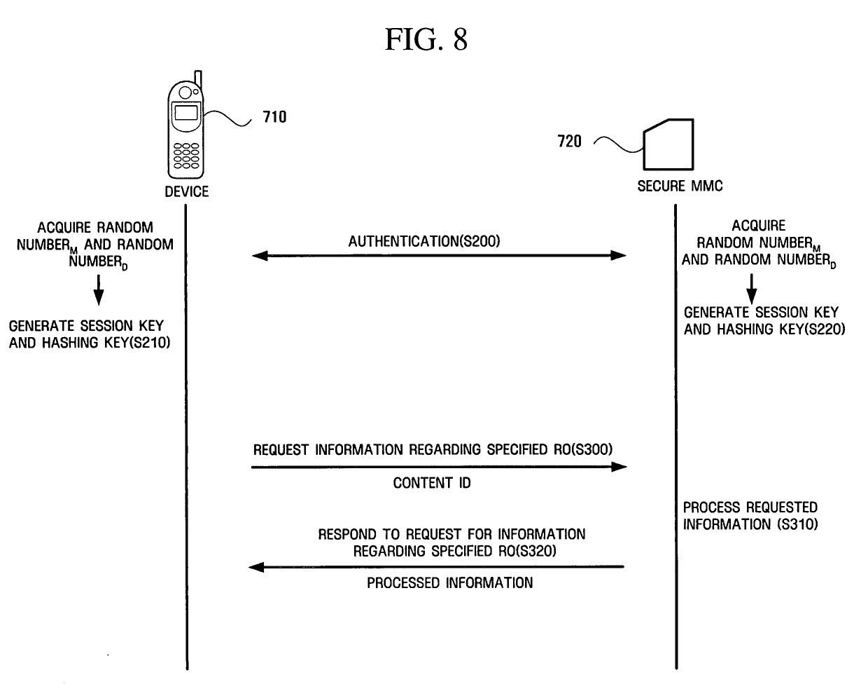

When receiving a request for information regarding an RO from a device, the DRM agent 420 selectively processes information contained in the RO and provides the processed information to the device via the interface module 410, which will be described in detail with reference to FIG. 8 later.

In addition, the DRM agent 420 retrieves an RO to be removed. In detail, the DRM agent 420 retrieves an RO according to a condition of an RO to be removed, such as an RO ID or an ID list, transmitted from a device. The retrieved RO is removed. The removing of an RO may indicate physically removing the RO or informing that the RO is unnecessary by changing particular information of the RO. In addition, the DRM agent 420 has a function of physically removing an unnecessary RO in response to a request.

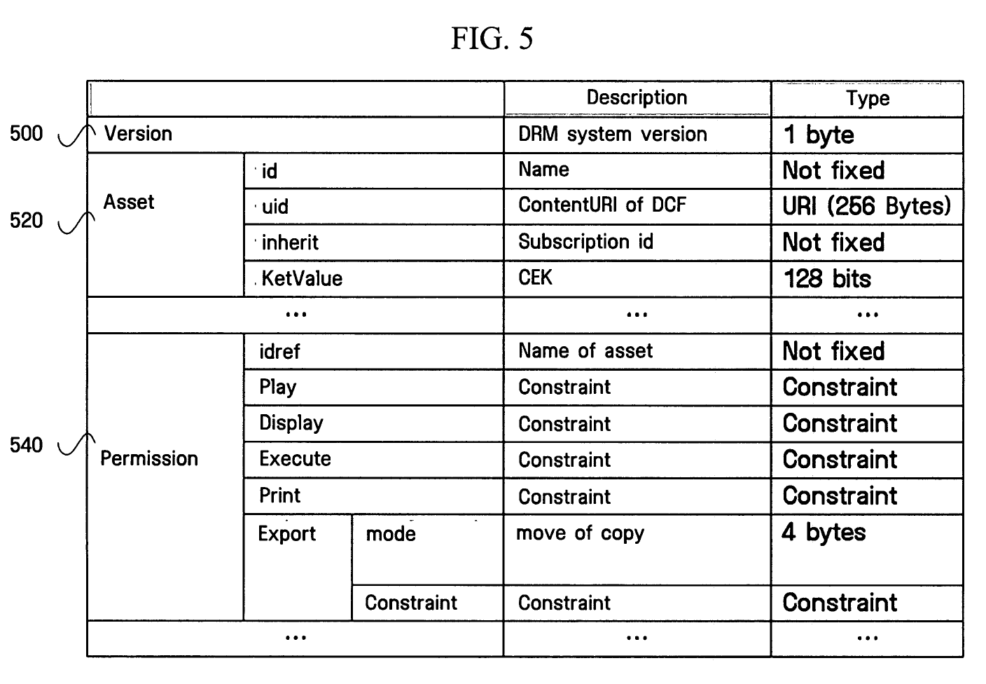

FIG. 5 is a table illustrating the format of an RO according to an exemplary embodiment of the present invention.

The RO includes a version field 500, an asset field 520, and a permission field 530.

The version field 510 contains version information of a DRM system. The asset field 520 contains information regarding content data, the consumption of which is managed by the RO. The permission field 530 contains information regarding usage and action that are permitted by a right issuer with respect to the content protected through DRM.

The information stored in the asset field 520 will be described in detail.

“id” information indicates an identifier used to identify the RO.

“uid” information is used to identify the content the usage of which is dominated by the RO and is a uniform resource identifier (URI) of content data of a DRM content format (DCF).

“inherit” information specifies the inheritance relationship between assets the usage of which is dominated by the RO and contains information regarding a parent asset. If inheritance relationship is present between two assets, a child asset inherits all rights of a parent asset.

“KeyValue” information contains a binary key value used to encrypt the content, which is referred to as a content encryption key (CEK). The CEK is a key value used to decrypt encrypted content to be used by a device. When the device receives the CEK from a secure MMC, it can use the content.

The information stored in the permission field 530 will be described in detail.

“idref” information has a reference value of the “id” information stored in the asset field 520.

“Permission” is a right to use content permitted by the right issuer. Types of permission include “Play”, “Display”, “Execute”, “Print”, and “Export”.

“Play” is a right to display DRM content in an audio/video format. Accordingly, a DRM agent does not allow an access based on “Play” with respect to content such as JAVA games that cannot be expressed in the audio/video format.

The Play permission may optionally have a constraint. If a specified constraint is present, the DRM agent grants a right to Play according to the specified constraint. If no specified constraints are present, the DRM agent grants unlimited Play rights.

The Display permission indicates a right to display DRM content through a visual device. A DRM agent does not allow an access based on Display with respect to content such as gif or jpeg images that cannot be displayed through the visual device.

The Execute permission indicates a right to execute DRM content such as JAVA games and other application programs. The Print permission indicates a right to generate a hard copy of DRM content such as jpeg images.

The Export permission indicates a right to send DRM contents and corresponding ROs to a DRM system other than an open mobile alliance (OMA) DRM system or a content protection architecture. The Export permission must have a constraint. The constraint specifies a DRM system of a content protection architecture to which DRM content and its RO can be sent. The Export permission is divided into a move mode and a copy mode. When an RO is exported from a current DRM system to another DRM system, the RO is deleted from the current DRM system in the move mode but is not deleted from the current DRM system in the copy mode.

The Move permission is divided into a device-to-secure MMC move and a secure MMC-to-device move. In the device-to-secure MMC move, an RO in a device is sent to a secure MMC and the original RO in the device is deactivated. Similar operations are performed in the secure MMC-to-device move.

The Copy permission is divided into a device-to-secure MMC copy and a secure MMC-to-device copy. In the device-to-secure MMC copy, an RO in a device is sent to a secure MMC, but unlike the Move permission, the original RO in the device is not deactivated. Similar operations are performed in the secure MMC-to-device copy.

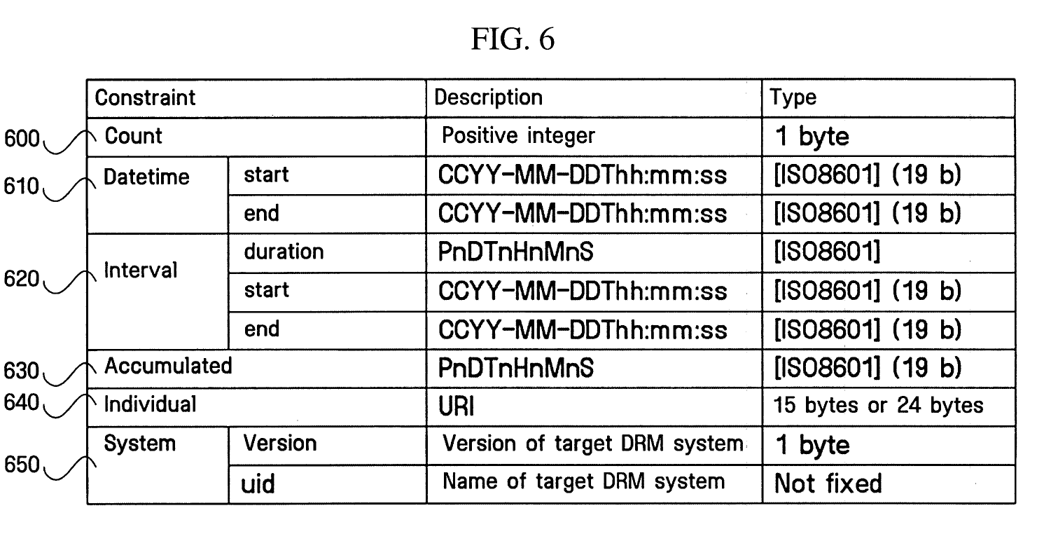

FIG. 6 is a table illustrating constraints given to the permission shown in FIG. 5.

The constraint information of the permission restricts the consumption of digital content.

A Count constraint 600 has a positive integer value and specifies the number of times of permission given to content. A DRM agent does not permit access to DRM content by greater than the number of times of permission specified by a value of the Count constraint. In addition, when the value of the Count constraint is not a positive integer, the DRM agent does not permit access to DRM content. Meanwhile, a Time Count constraint includes a count subfield and a timer subfield to specify the count of permissions granted to content during a period of time defined by a timer.

A Datetime constraint 610 specifies a time limit of the permission and optionally includes a start item and an end item. When the start item is specified, access is not permitted before a particular time on a particular date. When the end item is specified, access is not permitted after a particular time on a particular date. Accordingly, if a value of the start item is greater than that of the end item, a DRM agent does not permit access to the DRM content.

In the format of the start and end items, CC denotes century, YY denotes year, MM denotes month, DD denotes date, T denotes a discriminator between date and time, and hh:mm:ss denotes hour:minute:second, respectively.

An Interval constraint 620 specifies a duration for which a right is effective on DRM content and optionally includes a start item and an end item. When the start item is specified, consumption of DRM content is permitted during a period of time specified by the Interval constraint after a particular time on a particular date. When the end item is specified, consumption of DRM content is permitted during a period of time specified by the Interval constraint before a particular time on a particular date. Accordingly, a DRM agent does not permit access to DRM content after an accumulated time specified by a value of the Interval constraint has lapsed. In the format of a Duration item, P2Y10M15DT10H30M20S, for example, indicates the duration of 2 years, 10 months, 15 days, 10 hours, 30 minutes and 20 seconds.

An Accumulated constraint 630 specifies a maximum measured time for which a right can be performed on DRM content. A DRM agent does not permit access to DRM content after an accumulated time specified by a value of the Accumulated constraint has lapsed.

An Individual constraint 640 specifies an individual to whom DRM content is bound. That is to say, the Individual constraint 640 specifies the individual using a URI of the individual. Accordingly, if a device user's identity is not identical with the identity of the person permitted to use the DRM content, a DRM agent does not permit access to the DRM content.

A System constraint 650 specifies a DRM system or a content protection structure to which content and a rights object can be exported. A Version item indicates version information of the DRM system or the content protection structure. A UID item indicates a name of the DRM system or the content protection structure.

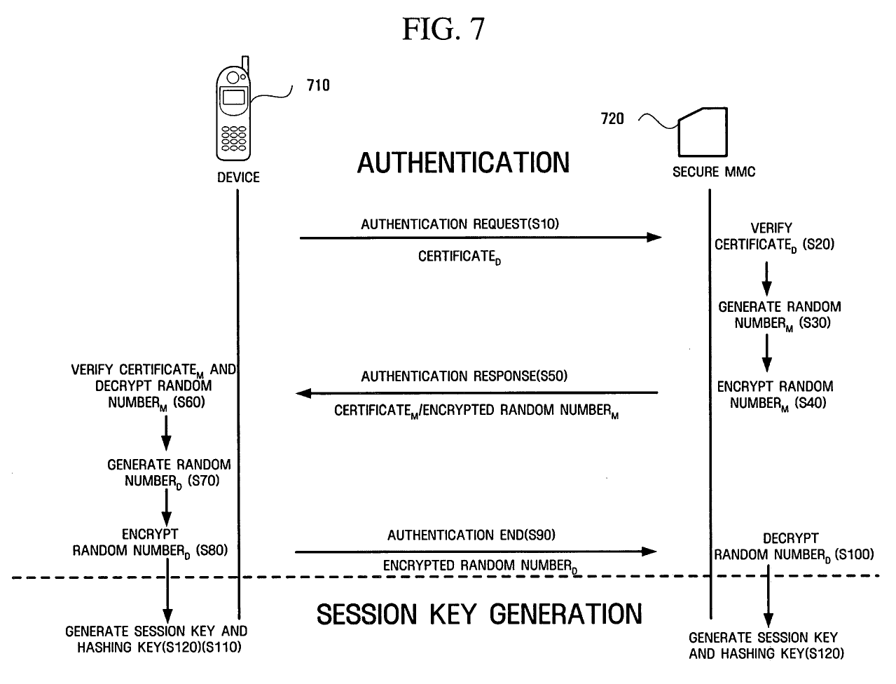

FIG. 7 illustrates an authentication procedure according to an exemplary embodiment of the present invention.

Authentication is a procedure in which a device 710 and a secure MMC 720 authenticate each other's genuineness and exchange random numbers for generation of a session key. A session key can be generated using a random number obtained during authentication. In FIG. 7, descriptions above arrowed lines relate to a command requesting another device to perform a certain operation and descriptions below the arrow-headed lines relate to a parameter needed to execute the command or data transported. In an exemplary embodiment of the present invention, the device 710 issues all commands for the authentication and the secure MMC 720 performs operations needed to execute the command. For example, the device 710 may send a command such as an authentication response to the secure MMC 720. Then, the secure MMC 720 sends a certificateₘ and an encrypted random number_{M} to the device 710 in response to the authentication response. In another exemplary embodiment of the present invention, both of the device 710 and the secure MMC 720 may issue commands. For example, the secure MMC 720 may send the authentication response together with the certificateₘ and the encrypted random number_{M} to the device 710. Detailed descriptions of the authentication procedure will be set forth below.

In operation S10, the device 710 sends an authentication request to the secure MMC 720. When requesting authentication, the device 710 sends a device public key_{D} to the secure MMC 720. For example, the device public key_{D} may be sent by sending a device certificate_{D} issued to the device 710 by a certification authority. The device certificate_{D} is signed with a digital signature of the certification authority and contains a device ID and the device public key_{D}. Based on the device certificate_{D}, the secure MMC 720 can authenticate the device 710 and obtain the device public key_{D}.

In operation S20, the secure MMC 720 verifies whether the device certificate_{D} is valid using a certificate revocation list (CRL). If the device certificate_{D} is registered in the CRL, the secure MMC 720 may reject the authentication with the device 710. If the device certificate_{D} is not registered in the CRL, the secure MMC 720 obtains the device public key_{D} using the device certificate_{D}.

In operation S30, the secure MMC 720 generates a random number_{M}. In operation S40, the random number_{M} is encrypted using the device public key_{D}. In operation S50, an authentication response procedure is performed by sending an authentication response from the device 710 to the secure MMC 720 or from the secure MMC 720 to the device 710. During the authentication response procedure, the secure MMC 720 sends a secure MMC public key_{M} and encrypted random number_{M} to the device 710. In an exemplary embodiment of the present invention, instead of the secure MMC public key_{M}, a secure MMC certificate_{M} may be sent to the device 710. In another exemplary embodiment of the present invention, the secure MMC 720 may send its digital signatures to the device 710 together with the encrypted random number_{M} and the secure MMC certificateₘ.

In operation S60, the device 710 receives the secure MMC certificate_{M} and the encrypted random number_{M}, authenticates the secure MMC 720 by verifying the secure MMC certificate_{M}, obtains the secure MMC public key_{M}, and obtains the random number_{M} by decrypting the encrypted random number_{M} using the device public key_{D}. In operation S70, the device 710 generates a random number_{D}. In operation S80, the random number_{D} is encrypted using the secure MMC public key_{M}. Thereafter, an authentication end procedure is performed in operation S90 where the device 710 sends the encrypted random number_{D} to the secure MMC 720. In an exemplary embodiment of the present invention, the device 710 may send its digital signature_{D} to the secure MMC 720 together with the encrypted random number_{D}.

In operation S100, the secure MMC 720 receives and decrypts the encrypted random number_{D}. As a result, the device 710 and the secure MMC 720 are provided with a random number generated by each other. Here, since both the device 710 and the secure MMC 720 generate their own random numbers and use each other's random numbers, randomness can greatly increase and secure mutual authentication is possible. In other words, even if one of the device 710 and the secure MMC 720 has weak randomness, the other of them can supplement randomness.

In operations S110 and S120, the device 710 and the secure MMC 720 that share each other's random numbers generate their session keys and hashing keys using both of their two random numbers. To generate a session key and hashing key using the two random numbers, an algorithm that has been published may be used. A simplest algorithm is performing an XOR operation on the two random numbers. Once the session keys and hashing keys are generated, diverse operations protected by DRM can be performed between the device 710 and the secure MMC 720.

FIG. 8 is a flowchart of a protocol by which a device 710 acquires information regarding a specified RO from a secure MMC 720 in an exemplary embodiment of the present invention.

Before the device 710 requests the information regarding the specified RO from the secure MMC 720, authentication between the device 710 and the secure MMC 720 is performed in operation S200. In operations S210 and S220, each of the device 710 and the secure MMC 720 generates a session key for encryption and decryption performed during communication between the device 710 and the secure MMC 720 and a hashing key for a hashing algorithm that generates a value indicating whether information provided from the secure MMC 720 is modified.

In operation S300, the device 710 requests the information regarding the specified RO from the secure MMC 720. Here, to specify an RO the information of which is to be acquired, the device 710 may send a content ID or an RO ID. When the device 710 has a parent RO, the RO ID includes an ID of the parent RO to acquire information regarding a child RO corresponding to the parent RO.

Here, the parent RO and the child RO are in a relationship in which one RO is defined by inheriting a permission and a constraint from another RO. The parent RO defines a permission and a constraint for DRM content and the child RO inherits them. The child RO refers to the content. However, the parent RO does not directly refer to the content itself but refers to its child RO. When access to the content is permitted according to permission information regarding the child or parent RO, a DRM agent considers a constraint on the permission granting the access and all upper level constraints on the parent and child ROs. As a result, a rights issuer can support a subscription business model.

Alternatively, an ID of an RO the information of which is to be acquired may be included.

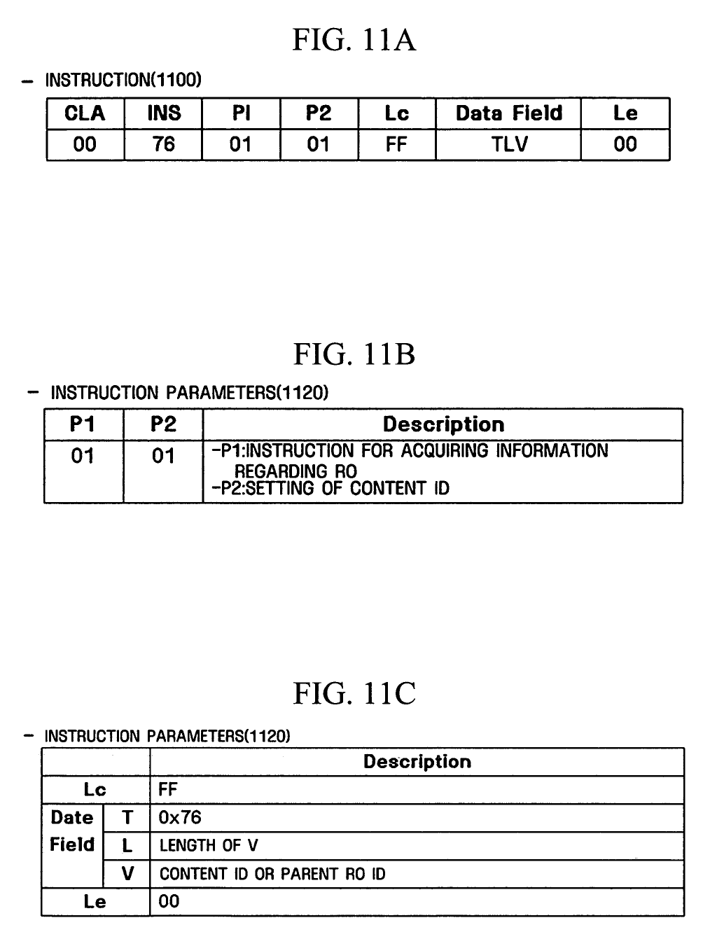

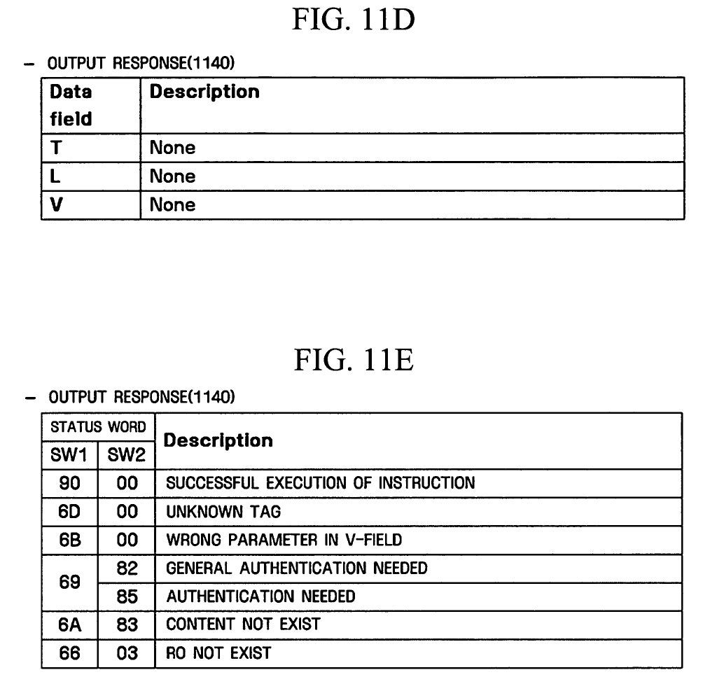

Information specifying an RO may be sent when the device 710 requests the information in operation S300 or may be sent through a special instruction before the device 710 requests the information. The special instruction will be described later with reference to FIG. 11.

In response to the request by the device 710, the secure MMC 720 retrieves and processes information regarding an RO corresponding to the content ID or the RO ID received from the device 710 in operation S310 and sends the processed information regarding the RO to the device 710 in operation S320.

In an exemplary embodiment of the present invention, the processed information regarding the RO selectively includes schematic information regarding right information represented by the RO among information items included in the RO. For example, the processed information may include an ID of content dominated by the right, a hash value indicating whether the content is modified, and permission information. However, the processed information regarding the RO does not include a CEK used to decrypt encrypted content because the device 710 requests the information regarding the RO to verify whether the secure MMC 720 has a right to use the content desired by a user and to identify the right possessed by the secure MMC 720.

In another exemplary embodiment of the present invention, the processing of the information regarding the RO may include converting a data format into a data format supported by the device 710 when the data format supported by the secure MMC 720 is not supported by the device 710.

One or more ROs may correspond to a particular content, and therefore, two or more types of permission information may be included in the information regarding the RO.

In an exemplary embodiment of the present invention, since the information regarding the RO transmitted to the device 710 does not include a CEK, the information does not need to be encrypted using the session key generated through the authentication between the device 710 and the secure MMC 720. To allow the device 710 to determine whether the information regarding the RO is modified, the information may include a hash value. The hash value may be generated using the hashing key generated through the authentication and a known hash algorithm, e.g., SHA1.

The device 710 recognizes the current status of possession of ROs needed to consume the particular content through a procedure for acquiring the information regarding the RO and requests a right to play, display, execute, print, or export the particular content from the secure MMC 720 according to the ROs that the secure MMC 720 possesses. When the secure MMC 720 possesses an RO corresponding to a requested permission, the secure MMC 720 encrypts the CEK using the session key and transmits the encrypted CEK to the device 710 to enable the device 710 to decrypt the particular content that has been encrypted.

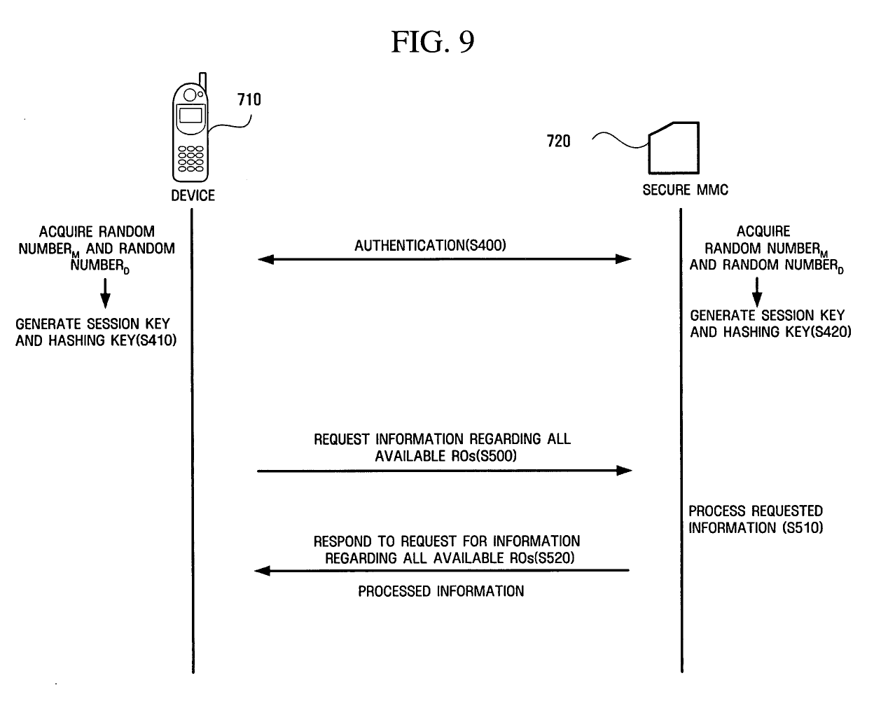

FIG. 9 is a flowchart of a protocol by which the device 710 acquires information regarding all available ROs from the secure MMC 720 in an exemplary embodiment of the present invention.

A user of the device 710 can identify ROs stored in the secure MMC 720 to then consume stored content or to then export or copy the content to another device according to the identified ROs.

Before the device 710 requests information regarding all available ROs from the secure MMC 720, authentication between the device 710 and the secure MMC 720 is performed in operation S400. In operations S410 and S420, each of the device 710 and the secure MMC 720 generates a session key for encryption and decryption and a hashing key.

Regardless of content to be consumed, the device 710 requests information regarding all available ROs from the secure MMC 720 in operation S500. Then, the secure MMC 720 retrieves all available ROs stored therein and processes information regarding them in operation S510 and sends the processed information to the device in operation S520.

In an exemplary embodiment of the present invention, the processed information includes information regarding all available ROs stored in the secure MMC 720. For example, the processed information may include an ID of each RO, an ID of content dominated by each RO, and the number of content IDs. However, the processed information does not include a CEK used to decrypt encrypted content because the device 710 requests the information regarding the all available ROs to identify rights to contents possessed by the secure MMC 720.

In another exemplary embodiment of the present invention, the processing of the information regarding the all available ROs may include converting a data format into a data format supported by the device 710 when the data format supported by the secure MMC 720 is not supported by the device 710.

All available ROs stored in the secure MMC 720 may be two or more in number. In an exemplary embodiment of the present invention, when two or more available ROs are stored in the secure MMC 720, templates individually containing information regarding the ROs may be linked to a single list and transmitted to the device 710 at one time.

After receiving the information regarding all available ROs, the device 710 can manage the ROs by removes unnecessary rights, purchasing needed rights, and move some rights to another device.

In an exemplary embodiment of the present invention, since the information regarding all available ROs transmitted to the device 710 does not include a CEK, the information does not need to be encrypted using the session key generated through the authentication between the device 710 and the secure MMC 720. To allow the device 710 to determine whether the information regarding the RO is modified, the information may include a hash value. The hash value may be generated using the hashing key generated through the authentication and a known hash algorithm, e.g., SHA1.

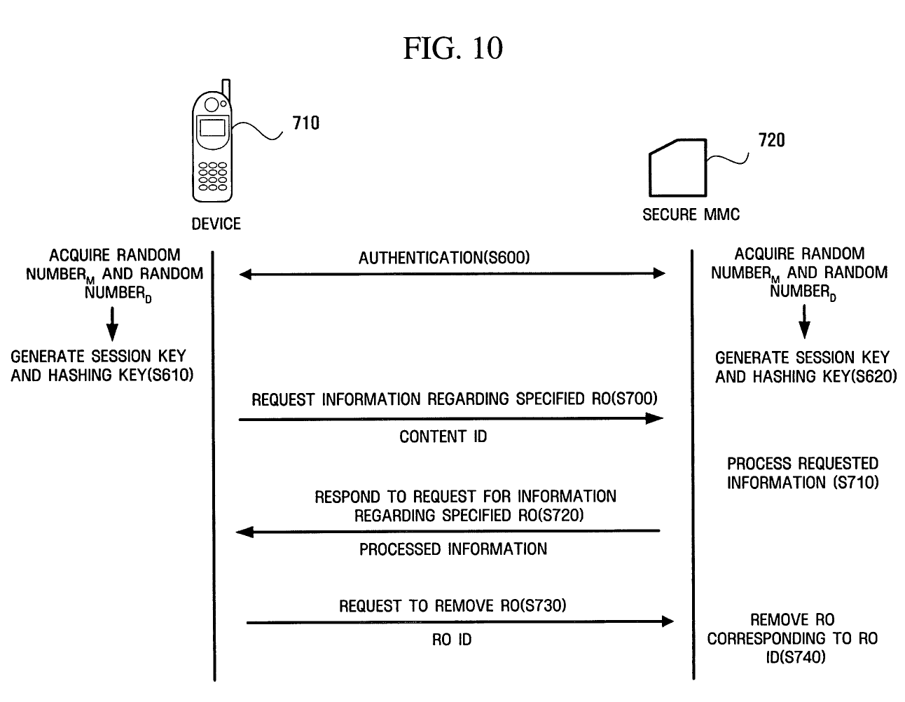

FIG. 10 is a flowchart of a protocol for removing an RO specified by the device 710 from the secure MMC 720 in an exemplary embodiment of the present invention.

Before the device 710 requests the secure MMC 720 to remove a specified RO, authentication between the device 710 and the secure MMC 720 is performed in operation S600. In operations S610 and S620, each of the device 710 and the secure MMC 720 generates a session key for encryption and decryption performed during communication between the device 710 and the secure MMC 720 and a hashing key for a hashing algorithm that generates a value indicating whether information is modified.

To request to remove the specified RO, the device 710 must know whether the specified RO exists. To know the existence/non-existence of the specified RO, in operations S700 through 720, the device 710 acquires information regarding the specified RO to be removed using the protocol illustrated in FIG. 8.

In operation S730, the device 710 encrypts an ID of the RO to be removed and a send sequence counter (SSC) indicating a transmission sequence in the current protocol using the session key to request removal of the RO. The SSC is a value increasing whenever a command packet is transmitted to detect whether a command packet transmitted from the device 710 is lost or manipulated by an unauthorized invader during transmission. In operation S740, in response to the request to remove the RO, the secure MMC 720 decrypts the encrypted RO ID transmitted from the device 710 using the session key and removes the RO corresponding to the RO ID.

In another exemplary embodiment of the present invention, the device 710 may send IDs of two or more ROs to be removed. In detail, the device 710 generates and encrypts a list of RO IDs and transmits the encrypted list. Upon receiving the list, the secure MMC 720 decrypts the list and removes ROs corresponding to the RO IDs in the list. Here, an operation of removing a plurality of ROs is needed.

In still another exemplary embodiment of the present invention, instead of transmitting an ID of an RO to be removed, conditions of an RO to be removed may be set and transmitted. Here, an operation in which the secure MMC 720 retrieves an RO satisfying the conditions and removes it is needed. Accordingly, operations S700 through S720 for acquiring information regarding the RO stored in the secure MMC 720 illustrated in FIG. 10 are optional because even though the device 710 does not know the information regarding the RO stored in the secure MMC 720, the device 710 can send a request to remove an RO not having a Copy or Execute right to the secure MMC 720. The conditions may relate to a right such as Read, Copy, Move, Output, or Execute. The conditions may be for removing an RO that does not have a right to use based on a current time or for removing an RO for content that does not exist in the device 710 or the secure MMC 720. The conditions are encrypted and transmitted to the secure MMC 720. Then, the secure MMC 720 retrieves an RO satisfying the conditions and removes it.

Removing of an RO may indicate removing the RO from a device and also indicate marking the RO as removable at any time because the RO cannot be used. When removing of an RO is performed in a secure MMC at every request, time for removing and processing time may increase. Accordingly, information regarding an RO may be changed and then, only when storage space in the secure MMC is insufficient, unnecessary RO may be removed. In other words, an RO may be stored in a portion where an unnecessary RO has been stored.

Accordingly, in exemplary embodiments of the present invention, removing includes (1) a method of completely eliminating an RO from a portable storage device and (2) a method of changing particular information of an RO, for example, the “id” of the asset field shown in FIG. 5, into information indicating that the RO is unusable and thereafter removing the RO. An RO marked as unnecessary is completely eliminated from a secure MMC when storage space is insufficient or when an external request for removing is received.

FIGS. 11A through 11E illustrate examples of formats of an instruction, instruction parameters, and an output response which are used when a device transmits information regarding content desired by a user to a secure MMC in the protocol illustrated in FIG. 8 in an exemplary embodiment of the present invention.

Here, the instruction is SET_CO_INFO largely composed of a header field and data field (1100). The header field contains information identifying an instruction and the data field contains information regarding the instruction. A P1 (1120) field in the header field has a value indicating the instruction SET_CO_INFO. A T-field in the data field (1120) is a tag field having a tag value indicating the instruction SET_CO_INFO. An L-field in the data field has a value indicating a length of a V-field in the data field. The V-field has a value of a content ID. The V-field may have a value of an RO ID.

The instruction SET_CO_INFO simply transmits a content ID to a secure MMC, and therefore, an output response (1140) to this instruction has no values in its T-, L- and V-fields. A status word in the output response (1140) includes information on a result of executing the instruction SET_CO_INFO. The status word is expressed by a combination of SW1 and SW2 indicating one of “successful execution of the instruction”, “unknown tag”, “wrong parameter in the V-field”, “general authentication needed”, “authentication needed”, “verification failure”, and “number of attempts”, as shown in FIG. 11E.

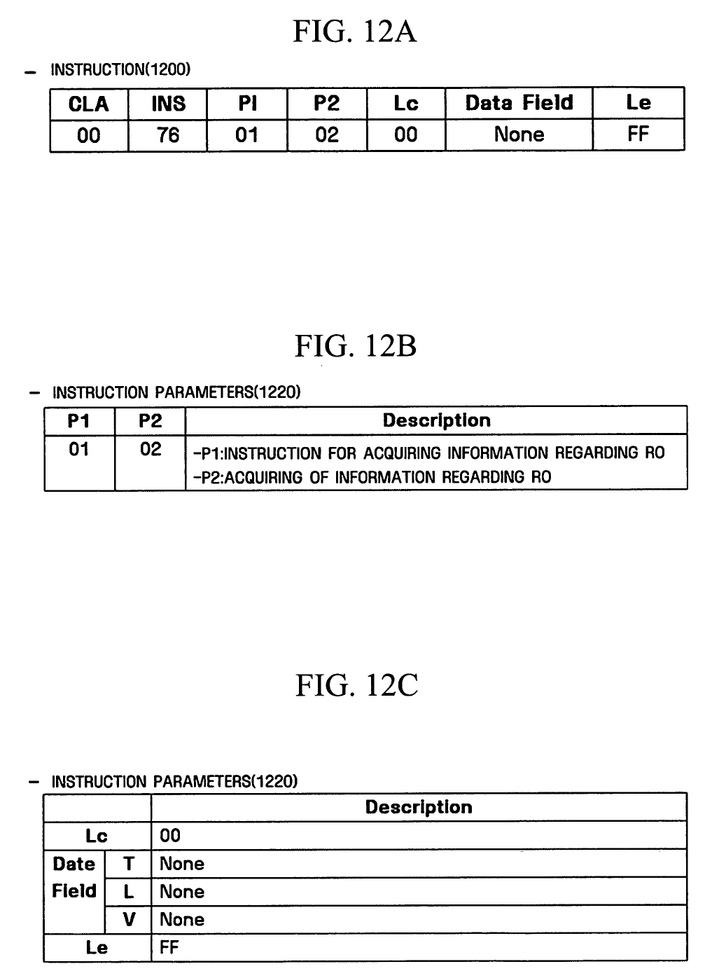

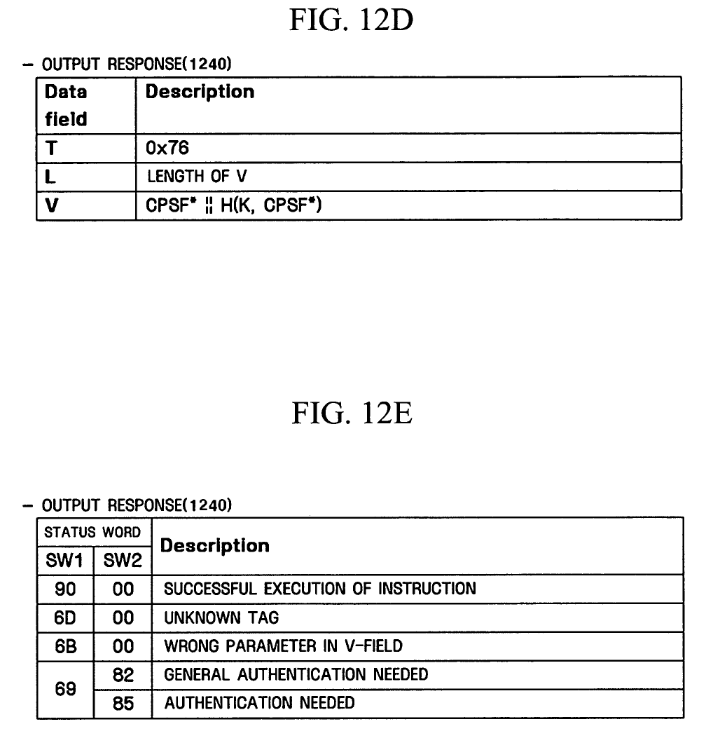

FIGS. 12A through 12E illustrate examples of formats of an instruction, instruction parameters, and an output response which are used when a device requests information regarding an RO corresponding to content from a secure MMC in the protocol illustrated in FIG. 8 in an exemplary embodiment of the present invention.

Here, the instruction is GET_RO_INFO 1200 and has a similar format to the instruction SET_CO_INFO.

A P1 field in a header field (1220) has a value indicating the instruction GET_RO_INFO. The instruction GET_RO_INFO requests the secure MMC to transmit information regarding an RO corresponding to content specified by the instruction SET_CO_INFO, and therefore, a data field (1220) included in the instruction GET_RO_INFO has no values.

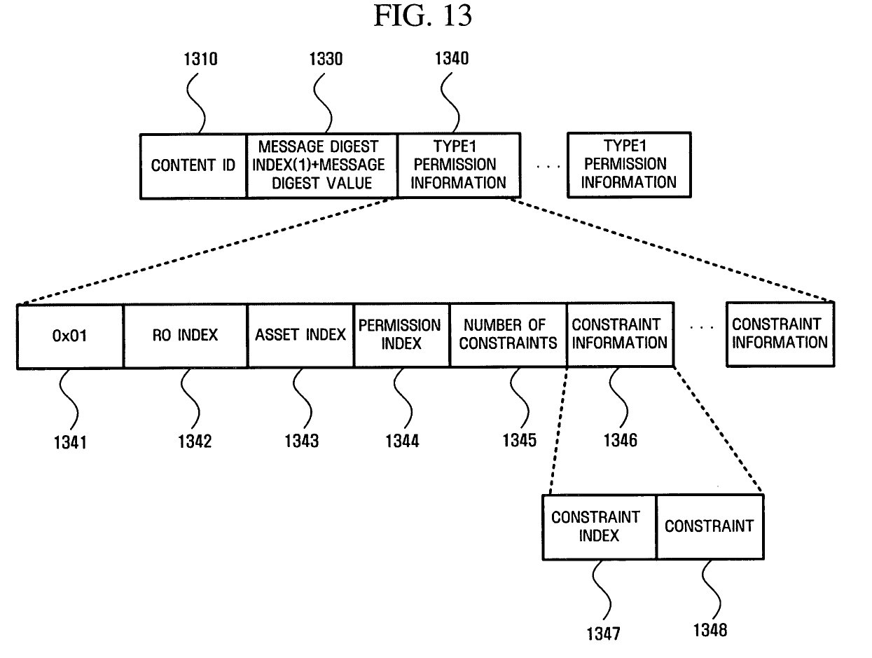

In an output response 1240, a data field includes information regarding the RO, and a status word informs a result of executing the instruction GET_RO_INFO. A T-field in the data field is a tag field having a tag value indicating a response to the instruction GET_MOVE_RO. An L-field has a value indicating a length of a V-field. The V-field has the encrypted value of the RO. Information regarding the RO of the V-field may be a combination of information regarding permission for the RO and a hash value indicating whether the information regarding permission for the RO is modified. The information regarding permission for the RO will be described in detail with reference FIGS. 13 through 15.

A status word is expressed by a combination of SW1 and SW2 indicating one of “successful execution of the instruction”, “unknown tag”, “wrong parameter in the V-field”, “general authentication needed,” and “authentication needed”.

FIG. 13 illustrate an example of the format of information regarding an RO (hereinafter, referred to as RO information) provided by a secure MMC in the protocol illustrated in FIG. 8.

The RO information fundamentally includes basic information for identifying an RO and permission information for the RO. Such data format is referred to as a current permission status format (CPSF). As described above, a CEK is excluded from the permission information. A permission status format specifies all types of permission requested for an RO and basic information regarding the RO. In an exemplary embodiment of the present invention, an RO is not directly transmitted, but a CPSF is transmitted, thereby reducing unnecessary overhead between a device and a secure MMC.

Referring to FIGS. 13 through 15, a CPSF according to an exemplary embodiment of the present invention includes a content ID field 1310, 1410, or 1510, a message digest index+message digest value field 1330, 1430, or 1530, and a permission information field 1340, 1440, or 1540.

In the content ID field 1310, 1410, or 1510, a content ID for identifying particular content that can be used via the RO is set.

In the message digest index+message digest value field 1330, 1430, or 1530, a message digest value is set for integrity protection of transmission data. The message digest value may be generated using a published hash algorithm (e.g., SHA1).

In the permission information field 1340, 1440, or 1540, permission information possessed by the RO is set.

The content of a CPSF may vary with a type of RO. In exemplary embodiments of the present invention, types of ROs are divided into general RO types, child RO types, and parent RO types. Type1 indicates a general RO. Type2 indicates a child RO. Type3 indicates a parent RO.

General ROs are ROs that have no relations with a subscription model (or a subscription business model) described in open mobile alliance digital rights management (OMA DRM) v2.0 rights expression language (REL).

ROs corresponding to the subscription model described in the OMA DRM v2.0 REL may be divided into child ROs and parent ROs. A child RO includes a CEK that is a right to use encrypted content. A parent RO includes a permission item and a constraint for the permission item. Other details of child ROs and parent ROs are described in the OMA DRM v2.0 REL. The details of the OMA DRM can be obtained at http://www.openmobilealliance.org/.

FIG. 13 illustrates a structure of a CPSF of a general RO according to an exemplary embodiment of the present invention.

The CPSF of a general RO may include at least one permission information field 1340, which includes subfields: a type field 1341, an RO index field 1342, an asset index field 1343, a permission index field 1344, a number-of-constraints field 1345, and a constraint information field 1346.

The type field 1341 includes information for identifying a type of the RO. Table 1 shows types of ROs.

TABLE 1

| Type of RO | Identification information (1 byte) |
|---|---|
| General RO | 0x01 |
| Child RO | 0x02 |
| Parent RO | 0x03 |

The RO index field 1342 and the asset index field 1343 include an internal RO ID and an internal asset ID, respectively, in a secure MMC. The internal RO ID and the internal asset ID may be respectively used to identifying an RO and an asset stored in the secure MMC.

The permission index field 1344 includes identification information for identifying a type of permission. The types of permission have been described with reference to FIG. 5.

The number-of-constraints field 1345 includes the number of constraint information fields 1346. Each constraint information field 1346 includes a constraint index field 1347 indicating a type of a constraint and a constraint field 1348 indicating the content of the constraint. The types of constraints have been described wit reference to FIG. 6.

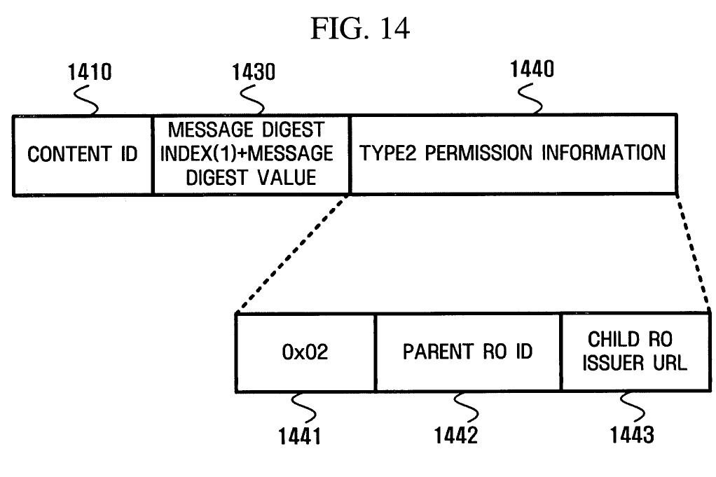

FIG. 14 illustrates a structure of a CPSF of a child RO according to an exemplary embodiment of the present invention.

Since only one child RO can be used for particular content, the CPSF includes a single permission information field.

Values respectively set in the content ID field 1410 and the message digest index+message digest value field 1430 have been described above.

The permission information field 1440 includes subfields: a type field 1441, a parent RO ID field 1442, and a child RO issuer uniform resource location (URL) field 1443.

The type field 1441 includes identification information for identifying a type of the rights object and has a value of “0×02”. The parent RO ID field 1442 includes identification information for identifying a parent rights object. The child RO issuer URL field 1443 includes a URL of a child RO issuer.

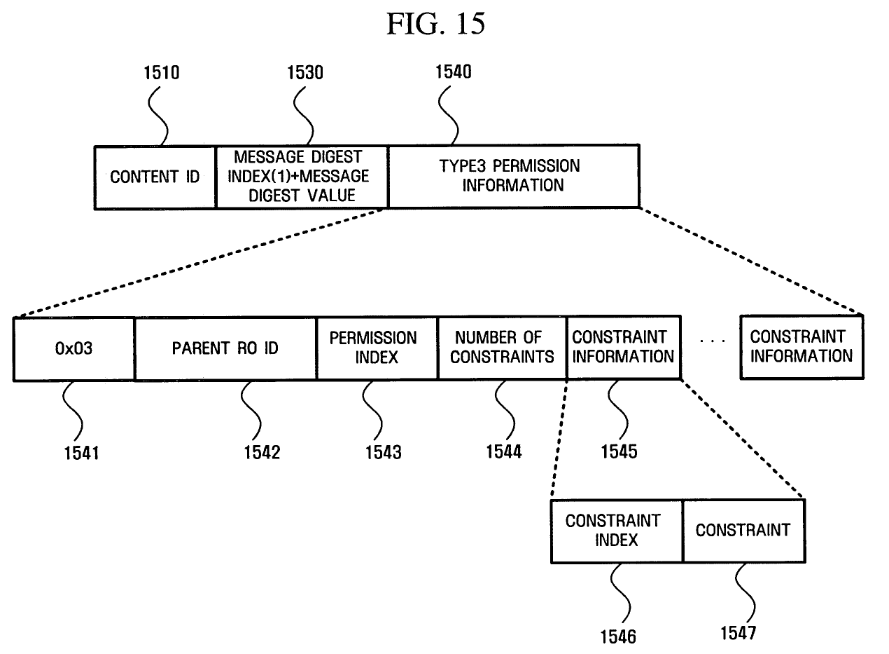

FIG. 15 illustrates a structure of a CPSF of a parent RO according to an exemplary embodiment of the present invention.

The content ID field 1510 has been described above. However, the parent RO complying with the subscription model described in the OMA DRM v2.0 REL does not have a CEK and a message digest value, and therefore, the message digest index+message digest value field 1530 maybe set to null.

Since there is only one parent RO allowing particular DRM content to be used, the CPSF includes a single permission information field 1540.

The permission information field 1540 includes subfields: a type field 1541, a parent RO ID field 1542, a permission index 1543, a number-of-constraints field 1544, and a constraint information field 1545. The type field 1541 includes identification information for identifying a type of the rights object and has a value of “0×03”.

The parent RO ID field 1542 includes identification information for identifying the parent rights object.

The permission index field 1543, the number-of-constrains field 1544, and the constraint information field 1545 include the same type of information as the permission index field 1344, the number-of-constrains field 1345, and the constraint information field 1346 shown in FIG. 13.

Meanwhile, a secure MMC may include both of a general RO and a child RO that allow particular content to be played or both of a general RO and a parent RO that allow particular content to be played.

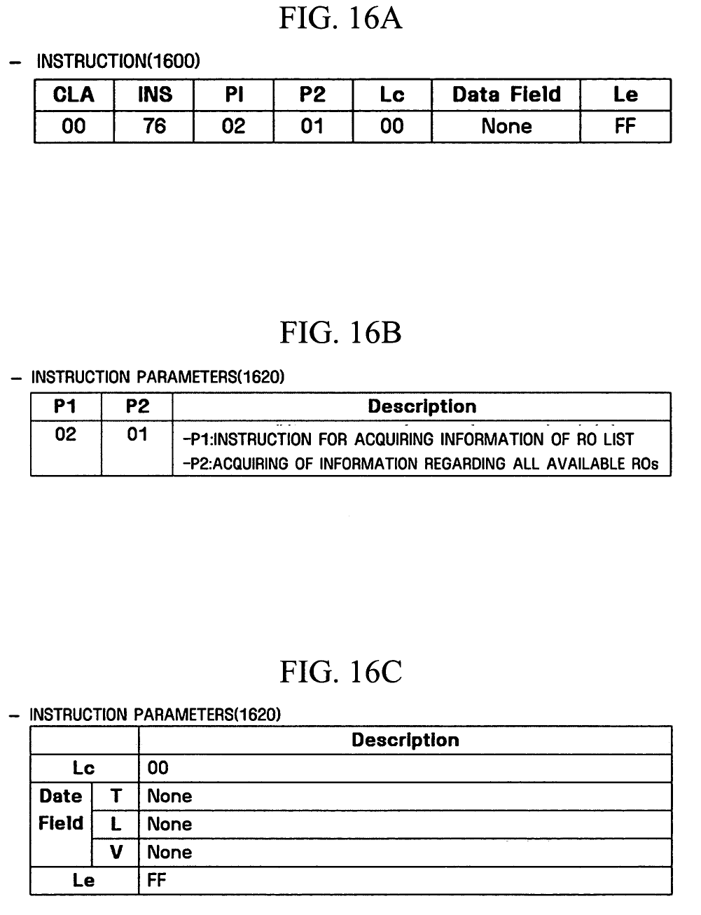

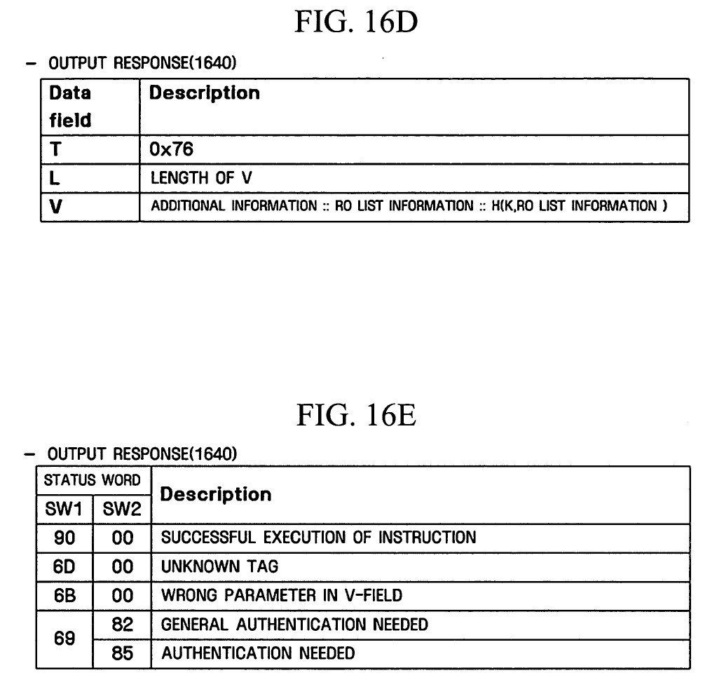

FIGS. 16A through 16E illustrate examples of formats of an instruction, instruction parameters, and an output response which are used when a device requests information regarding all available ROs in the protocol illustrated in FIG. 9 in an exemplary embodiment of the present invention.

Here, the instruction is GET_RO_LIST composed of a header field and data field (1600). The header field contains information identifying an instruction and the data field contains information regarding the instruction. A P1 field in the header field has a value indicating the instruction GET_RO_LIST. The instruction GET_RO_LIST requests to transmit information of a list of all available ROs stored in a secure MMC, and therefore, the data field of the instruction GET_RO_LIST has no values (1620).

A data field of an output response 1640 includes information regarding ROs, and a status word informs a result of executing the instruction. A T-field in the data field is a tag field having a tag value indicating the output response (1640) is a response to the instruction GET_RO_LIST. An L-field in the data field has a value indicating a length of a V-field in the data field. The V-field includes information of the list of all available ROs.

A status word is expressed by a combination of SW1 and SW2 indicating one of “successful execution of the instruction”, “unknown tag”, “wrong parameter in the V-field”, “general authentication needed,” and “authentication needed”, as shown in FIG. 16E.

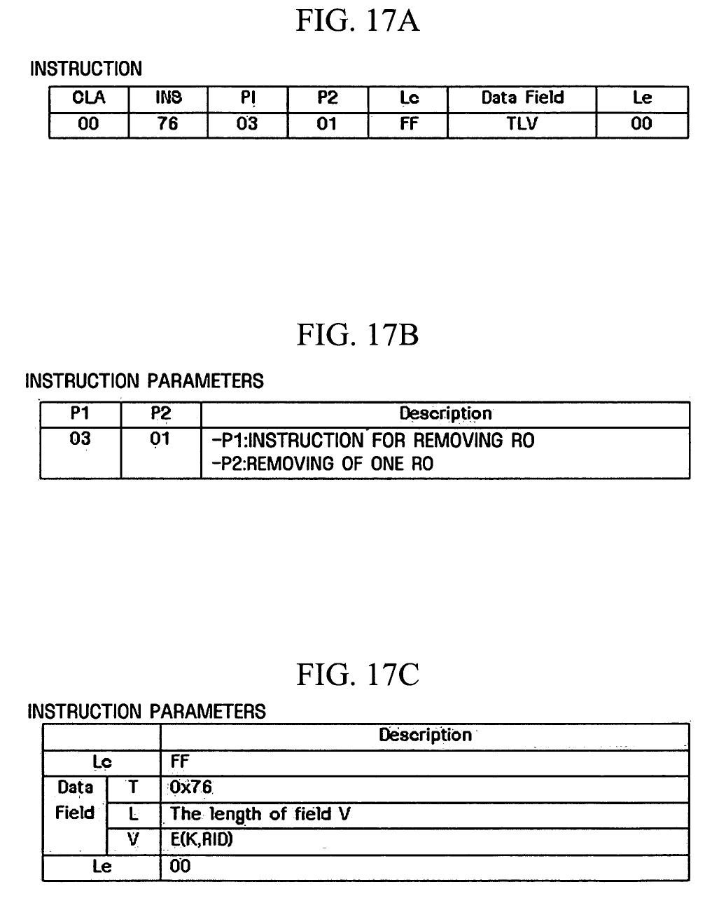

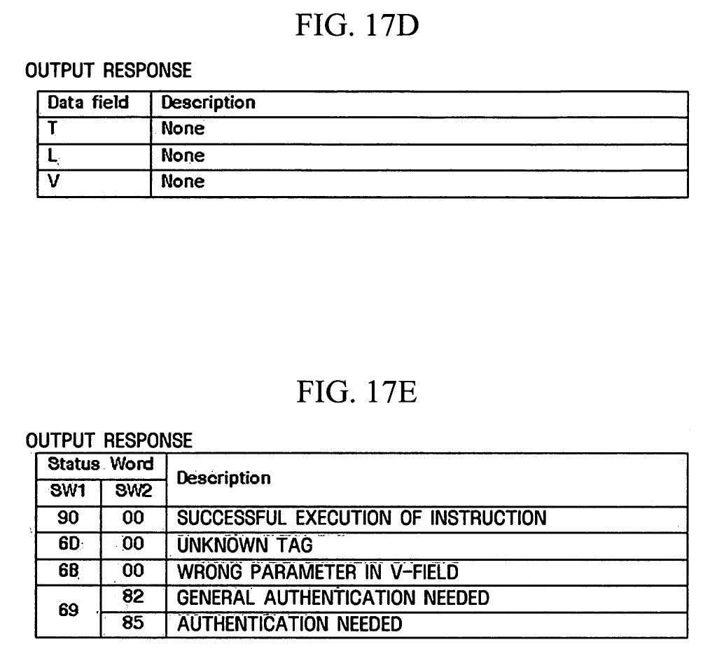

FIGS. 17A through 17E illustrate examples of formats of an instruction, instruction parameters, and an output response, which are used when a device requests a secure MMC to remove a particular RO in the protocol illustrated in FIG. 10 in an exemplary embodiment of the present invention.

Here, the instruction is SET_DELETE_RO including a CLA field and an INS field which indicate a group of instructions. Accordingly, instructions relating to removing have the same values in the CLA field and the INS field. Various instructions relating to removing are distinguished from one another by a P1 field and a P2 field. A data field of the instruction includes an encrypted ID of an RO to be removed. The data field includes a tag (T) field, a length (L) field, and a value (V) field. The T-field includes a category of the instruction. The L-field includes a length of data included in the V-field. The V-field includes the encrypted ID of the RO to be removed.

In an output response sent by the secure MMC receiving the instruction SET_DELETE_RO, a status word is expressed by values of SW1 and SW2 to indicate whether removing has succeeded, whether data included in the T-field is erroneous, whether an error is present in the V-field, and whether authentication is needed.

In concluding the detailed description, those skilled in the art will appreciate that many variations and modifications can be made to the exemplary embodiments without substantially departing from the principles of the present invention. Therefore, the disclosed exemplary embodiments of the invention are used in a generic and descriptive sense only and not for purposes of limitation.

According to the present invention, a device requests information regarding an RO from a portable storage device, receives the information regarding the RO from the portable storage device, and removes an unnecessary RO, thereby easily and efficiently managing ROs.

1. A method of acquiring information regarding a digital rights object, the method comprising:
receiving a request for data on a rights object from a device;
processing the data on the rights object in response to the request to generate processed data; and
providing the processed data to the device.

2. The method of claim 1, further comprising, before the processing of the data, performing authentication with the device and generating an encryption key.

3. The method of claim 2, wherein the encryption key comprises a session key and a hashing key.

4. The method of claim 1, wherein the processing of the data comprises:
accessing a rights object corresponding to one of a content identifier and a rights object identifier, which is provided by the device;
processing the data on the rights object which is accessed.

5. The method of claim 1, wherein the processed data comprises information included in the rights object.

6. The method of claim 5, wherein the processed data comprises a content identifier, information indicating whether content is modified, permission information, and information indicating whether other information is modified.

7. The method of claim 6, wherein the information indicating whether the other information is modified comprises information indicating a transmission sequence of the request from the device.

8. The method of claim 6, wherein the permission information comprises at least two types of permission information.

9. The method of claim 1, wherein the processed data is converted into a format supported by the device.

10. A method of acquiring information regarding a digital rights object, the method comprising:
performing authentication with a portable storage device and generating an encryption key;
requesting data on a rights object from the portable storage device; and
receiving processed data on the rights object from the portable storage device.

11. The method of claim 10, wherein the encryption key comprises a session key and a hashing key.

12. The method of claim 10, further comprising converting the processed data.

13. The method of claim 12, wherein the converting of the processed data comprises verifying whether the processed data is modified.

14. The method of claim 12, wherein the converting of the processed data comprises converting the processed data into a format supported by the device.

15. The method of claim 10, wherein the processed data comprises information in the rights object.

16. The method of claim 15, wherein the processed data comprises a content identifier, information indicating whether content is modified, permission information, and information indicating whether other information is modified.

17. The method of claim 16, wherein the information indicating whether the other information is modified comprises information indicating a transmission sequence from the request from the device.

18. A method of acquiring information regarding a digital rights object, the method comprising:
receiving a request for data on all available rights objects from a device;
accessing all of the available rights objects in response to the request and processing the data on all of the available rights objects to generate processed data; and
providing the processed data to the device.

19. The method of claim 18, further comprising, before the processing of the data, performing authentication with the device and generating an encryption key.

20. The method of claim 19, wherein the encryption key comprises a session key and a hashing key.

21. The method of claim 18, wherein the processed data comprises information included in the rights object.

22. The method of claim 21, wherein the processed data comprises a rights object identifier, a content identifier, information indicating whether content is modified, permission information, and information indicating whether other information is modified.

23. The method of claim 22, wherein the information indicating whether the other information is modified comprises information indicating a transmission sequence of the request from the device.

24. The method of claim 18, wherein the processed data is converted into a format supported by the device.

25. The method of claim 21, wherein the permission information comprises at least two types of permission information.

26. A method of acquiring information regarding a digital rights object, the method comprising:
performing authentication with a portable storage device and generating an encryption key;
requesting data on all available rights objects from the portable storage device; and
receiving processed data on all of the available rights objects from the portable storage device.

27. The method of claim 26, wherein the encryption key comprises a session key and a hashing key.

28. The method of claim 26, further comprising converting the processed data.

29. The method of claim 28, wherein the converting of the processed data comprises verifying whether the processed data is modified.

30. The method of claim 28, wherein the converting of the processed data comprises converting the processed data into a format supported by the device.

31. The method of claim 26, wherein the processed data comprises information included in the rights object.

32. The method of claim 31, wherein the processed data comprises a rights object identifier, a content identifier, information indicating whether content is modified, permission information, and information indicating whether other information is modified.

33. The method of claim 32, wherein the information indicating whether the other information is modified comprises information indicating a transmission sequence of the request from the device.

34. A method of removing a digital rights object, the method comprising:
selecting information regarding a rights object to be removed;
encrypting the information regarding the rights object which is selected using a common encryption key to generate encrypted information;
embedding the encrypted information regarding the rights object into a signal to be transmitted to a portable storage device; and
transmitting the signal to the portable storage device.

35. The method of claim 34, further comprising, before the selecting of the information, receiving information regarding the rights object to be removed from the portable storage device.

36. The method of claim 34, further comprising, before the selecting of the information, performing authentication with the portable storage device using a public-key scheme and generating the common encryption key.

37. The method of claim 34, wherein the selected information regarding the rights object is a rights object identifier.

38. The method of claim 34, wherein the selected information regarding the rights object is information on whether a rights object is usable.

39. A method of removing a digital rights object, the method comprising:
receiving encrypted rights object removal information from a device;
decrypting the encrypted rights object removal information using a common encryption key to generate decrypted rights object removed information;
accessing a rights object corresponding to the decrypted rights object removal information; and
removing the rights object which is accessed.

40. The method of claim 39, further comprising, before the receiving of the encrypted rights object removal information, providing information regarding the rights object to the device.

41. The method of claim 39, further comprising, before the receiving of the encrypted rights object removal information, performing authentication with the device and generating an encryption key.

42. The method of claim 39, wherein the decrypted rights object removal information comprises a rights object identifier.

43. The method of claim 39, wherein the decrypted rights object removal information comprises information on whether a rights object is usable.

44. The method of claim 39, wherein the removing of the rights object comprises completely eliminating the rights object.

45. The method of claim 39, wherein the removing of the rights object comprises changing predetermined information of the rights object to mark the rights object as unnecessary.

46. The method of claim 45, wherein the rights object marked as unnecessary is completely eliminated if storage space is insufficient.

47. The method of claim 45, wherein the rights object marked as unnecessary is completely eliminated in response to an external request.

48. A portable storage device comprising:
a storage module which stores a rights object for content;
an interface module which receives a request for the rights object from a device; and
a digital rights management (DRM) agent which accesses the rights object in response to the request, processes data on the rights object, and provides the data which is processed to the device through the interface module.

49. A device comprising:
an interface module communicably linked with a portable storage device;
a public-key encryption module which performs authentication with the portable storage device connected via the interface module;
an encryption key generation module which generates a session key and a hashing key which are shared with the portable storage device; and
a digital rights management (DRM) agent which requests data on a rights object from the portable storage device and receives processed data on the rights object from the portable storage device.

50. A device comprising:
a digital rights management (DRM) agent which selects information regarding a rights object to be removed and embeds the selected information regarding the rights object into a signal to be transmitted to a portable storage device;
an encryption module which encrypts the information regarding the rights object which is selected using a common encryption key to generate encrypted information regarding the rights object; and
an interface module which transmits the signal having the encrypted information regarding the rights object to the portable storage device.

51. The device of claim 50, wherein the selected information regarding the rights object comprises a rights object identifier.

52. The device of claim 50, wherein the selected information regarding the rights object comprises information on whether a rights object is usable.

53. A portable storage device comprising:
an interface module which receives encrypted rights object removal information from a device;
an encryption module which decrypts the rights object removal information using a common encryption key; and
a digital rights management (DRM) agent which accesses a rights object corresponding to the decrypted rights object removal information and removes the rights object.

54. The portable storage device of claim 53, wherein decrypted rights object removal information comprises a rights object identifier.

55. The portable storage device of claim 53, wherein the decrypted rights object removal information is information on whether a rights object is usable.

56. The portable storage device of claim 53, wherein the DRM agent removes the rights object by completely eliminating the rights object.

57. The portable storage device of claim 53, wherein the DRM agent removes the rights object by changing predetermined information of the rights object to mark the rights object as unnecessary.

58. The portable storage device of claim 57, wherein the rights object marked as unnecessary is completely eliminated if storage space is insufficient.

59. The portable storage device of claim 57, wherein the rights object marked as unnecessary is completely eliminated in response to an external request.

60. A recording medium having a computer readable program recorded therein, the program for executing a method of acquiring information regarding a digital rights object, the method comprising:
receiving a request for data on a rights object from a device;
processing the data on the rights object in response to the request to generate processed data; and
providing the processed data to the device.
